(19) United States
(12) Patent Application Publication
(10) Pub. No.: US 2006/0127701 A1
(43) Pub. Date: Jun. 15, 2006

(54) Method of manufacturing a device with a magnetic layer-structure

(75) Inventors: Jacobus Josephus Maria Ruigrok, Eindhoven (NL); Joannes Baptist Adrianus Dionisius Van Zon, Eindhoven (NL); Frederik Willem Maurits Vanhelmont, Eindhoven (NL); Willem Johannes Antonia Geven, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: koninklijke phillips electronics n.c.

(21) Appl. No.: 10/559,915

(22) PCT Filed: Jun. 1, 2004
(86) PCT No.: PCT/IB04/50811

§ 371 Date: Dec. 7, 2005

(30) Foreign Application Priority Data
Jun. 11, 2003 (EP) 03101695.9

(51) Int. Cl. G11B 5/39; B05D 5/12; B29C 71/04; H05B 6/02

(52) U.S. Cl. 428/811; 427/127; 427/532; 427/591

(57) ABSTRACT

A method of manufacturing a device with a magnetic layer-structure is disclosed, the method comprising the steps of:—forming the magnetic layer-structure (2),—heating the magnetic layer-structure with an electric current, wherein the electric current is a pulse (3) having a duration such that no substantial heat transfer from the layer-structure to the environment (4) of the layer-structure takes place, so that the temperature of said environment before and after the current pulse is substantially the same. Heat is substantially dissipated in the layer-structure. The method therefore allows the selection of physical processes in the layer-structure in order to optimize the magnetic or electrical characteristic of the magnetoresistive device, without disturbing the environment such as neighboring devices. The method can advantageously be used to set different magnetization directions (9, 10) in the bias layers (5,7) of different magnetoresistive devices (12,13,14,15) arranged in a Wheatstone bridge configuration (16), or to reduce offset in the output characteristic of said Wheatstone bridge.

The invention relates to a method of manufacturing a device with a magnetic layer-structure, the method comprising the steps of:

forming the magnetic layer-structure,

heating the magnetic layer-structure with an electric current

WO 00/02006 discloses a method of setting the magnetization direction of a bias layer in a magnetic multilayer of a magnetic sensing device. The bias layer is part of an artificial antiferromagnetic (AAF) system consisting of at least one bias layer, at least one flux conducting layer and at least one connecting layer that is arranged between said layers and connects them antiferromagnetically. In the method, a current is applied across the sensing device in order to heat the sensing device, e.g. the temperature is raised to above the blocking temperature of the bias layer. During the heating, a magnetic field is applied in the magnetization direction of the bias layer to be set. After a predetermined time period, the magnetic field is switched off. Then the temperature is brought back to the initial temperature and the magnetization direction of the bias layer is frozen.

A problem resides in that heat generated by the electric current applied across the magnetic sensing device heats up the environment and spreads over a large distance. A device present in the neighborhood of the magnetic sensing device is disturbed, and, especially in the presence of an applied magnetic field, the output characteristic of that neighboring device may be altered.

It is an object of the invention to obtain a method of manufacturing a device of the type mentioned in the opening paragraph, in which method the heat is substantially localized inside the magnetic layer-structure.

The object according to the invention is achieved in that the electric current is a pulse having a duration during such that no substantial heat transfer from the layer-structure to the environment of the layer-structure takes place, so that the temperature of said environment before and after the current pulse is substantially the same.

The magnetic layer-structure is subjected to the electric current pulse. The duration of the current pulse is shorter than the time scale on which substantial heat transfer to the environment of the layer-structure can take place. The environment of the layer-structure can be e.g. a substrate on which the layer-structure is provided, air, an electrically insulating layer, or a neighboring device. Because of the short duration of the current pulse no thermal equilibrium between the layer-structure and the environment of the layer-structure can occur. The heat associated with the current pulse is therefore substantially dissipated inside the layer-structure. After the pulse is terminated, the heat is rapidly distributed over the environment of the layer structure, leading to only a moderate temperature increase of the environment.

It is a major advantage that electrical or magnetic characteristics of the magnetic layer structure of the device can be changed selectively without altering the temperature in the vicinity, e.g. without disturbing a neighboring electronic or magnetic device.

WO 00/79298 discloses a method of manufacturing a sensing system with a magnetic characteristic. The system includes a set of magnetic devices in a balancing configuration, e.g. in a Wheatstone bridge configuration, and essentially each of said devices comprises a structure of layers including at least a first ferromagnetic layer and a second ferromagnetic layer with at least a separation layer of a non-magnetic material therebetween, said structure having at least a magnetoresistance effect. The method comprises the step of heating part of the system including at least one of the devices of said set while applying an external magnetic field over at least part of said system, the part including said at least one device. Said heating can be achieved by applying a current pulse, a laser pulse or a pulse from an electron beam or ion beam to or through the device.

A disadvantage of the known method is that there is still a large spreading of heat over a rather large distance: the temperature is raised over at least the total dimensions of one of the devices of the system. Because the device is rather large (of the order of (several) 100 μm²) and a temperature is achieved over the entire dimensions of the device, no localized heating within one device can be achieved. By heating the at least one device, the environment of the device is heated as well. Because of the rise in temperature of the environment the magnetoresistance output characteristic of a neighboring device of the system is altered when applying an external magnetic field. With the known method it is therefore impossible to achieve localized heating inside a magnetic layer-stack.

Heat transfer from the magnetic layer-structure to the environment is dominated by heat conduction. The magnetic layer-structure usually comprises a stack of metal layers provided on a substrate. The heat capacity of the stack of metal layers is generally of the same order of magnitude as that of the solid state material of the substrate, while the heat capacity of gases such as air is significantly smaller. When the magnetic layer-structure is subjected to an electric current pulse, a heat front moves very rapidly towards the substrate. Because of the relatively large volume of the substrate compared to that of the magnetic layer-structure, the heat generated in the layer structure is rapidly distributed over the entire volume of the substrate. Typically, once the heat is distributed in a volume that is twice the volume of the layer structure, the temperature will have dropped by a factor of 2.

Therefore, the temperature of the substrate after the current pulse remains substantially the same as the temperature before the current pulse.

In an advantageous method the electric current pulse is used to select a physical process in the layer-structure. Such a physical process can be: diffusion (of atoms), a change in composition at interfaces, a change in resistance, a change in strength or direction of pair ordering (easy axis orientation), a change in magnetization direction, a change in structure or phase (amorphous/crystalline/crystalline orientation), a change in stress and strain, or a change of the concentration of a dopant near the surface (or near an interface).

The transition of a physical process from a certain state to another certain state is dependent on the presence of (an) energy barrier(s) between these states. Such an energy barrier is also referred to as activation energy. The time constant for such a transition is dependent on the ratio between the energy barrier height(s) and the total thermal energy of the relevant process. Generally, this time constant τ can be expressed as an Arrhenius-like equation, such as e.g.
τ=τ₀.exp(E_{barrier}/kT)
in which τ₀ is a certain fixed time constant for the type of process considered (e.g. it can be equal to the reversed attempt frequency), E_{barrier} is an energy barrier and kT is the total thermal energy of the considered process. The time constant τ is therefore dependent on the temperature T. In the case of a short heating pulse, the achieved temperature T is dependent on the duration of the heating (pulse time) and the intensity of the heating (pulse amplitude), making τ(T)→τ(T(tₚᵤₗₛₑ,Aₚᵤₗₛₑ)) where tₚ is the pulse time and Aₚᵤₗₛₑ is the pulse amplitude. The population or occupation of the states is dependent on how long the process is allowed to overcome the energy barrier(s). The population is dependent on the ratio between the allowed time t and the time constant τ of the physical process. The time-dependent population is typically described by a Poisson-distribution such as exp(−t/τ) or exp(−t/τ(T(tₚᵤₗₛₑ,Aₚᵤₗₛₑ))). Since the temperature after the pulse drops rapidly, t is about equal to tₚᵤₗₛₑ.

Within one stack of magnetic multilayers it is therefore possible to select a physical process in a certain magnetic layer by using the right pulse time and pulse amplitude, provided the intrinsic material parameters τ₀ and/or E_{barrier} differ sufficiently from the intrinsic material parameters of another layer of the multilayer stack.

In an advantageous method the selectivity between processes can be enhanced by using a shorter pulse time and a higher amplitude of the current pulse.

A sequence of different pulses can advantageously be applied to select different physical processes. The heat capacitance and the volume of the layer-stack and the environment (such as a substrate) have to be taken into account when choosing the pulse duration and amplitude to guarantee that there is no substantial heat transfer from the layer-structure to its environment.

In an advantageous embodiment, the device can be a magnetoresistive device used e.g. as a magnetic sensing device for automotive applications, magnetic recording, smartcards, bio-sensors, 3D compasses e.g. used in mobile phones or as a magnetic memory device such as an MRAM in a data storage system.

The magnetic layer-structure can comprise at least one e.g. anti-ferromagnetic bias layer. The bias layer can be part of an artificial antiferromagnet (AAF) in the layer-structure.

In an advantageous method for setting the magnetization direction of the bias layer, a magnetic field is applied during the short pulse, which magnetic field is switched off after the temperature of the bias layer has decreased to below the Néel temperature. The Néel temperature is the critical temperature above which magnetic ordering vanishes in antiferromagnets (AF). As the critical temperature is approached from below, the sublattice magnetization drops continuously to zero. It is important to switch off the magnetic field after the bias layer has cooled down to below the Néel temperature where the magnetic moments within the grains of the AF layer are ordered. Preferably the magnetic field is switched off below the Blocking temperature. The Blocking temperature is generally lower than the Néel temperature and is defined as the temperature at which the average magnetization of the ensemble of all grains is substantially zero. Since the rotation of the magnetization is also a physical process involving (an) energy barrier(s), it is clear that the blocking temperature is dependent on the time scale within which it is measured. The blocking temperature increases when the considered time scale decreases.

The device can be used in the manufacture of a magnetic system having several magnetoresistive devices. The magnetic system can be a magnetic sensing system or a storage system comprising many magnetoresistive devices.

Preferably, at least four magnetoresistive devices are formed and arranged in a Wheatstone bridge configuration. The output characteristic of magnetoresistive devices in a Wheatstone bridge configuration is less sensitive to temperature effects than the magnetoresistance characteristic of a separate magnetoresistive device.

When the magnetoresistance effect is based on the GMR or the TMR effect, the magnetization of two of the at least four magnetoresistive devices is set in opposite directions in order to obtain a maximum sensitivity for a magnetic field to be measured. A similar process can be used for the AMR effect. Preferably, in the method a single deposition of a magnetic layer-stack is applied for the different magnetoresistive devices in the Wheatstone bridge configuration. In a first step the magnetization directions of the bias layers is set during deposition in an adequate magnetic field. The bias layers have a magnetization direction that corresponds to the direction of said external magnetic field, which is preferably irreversible at moderate temperatures in an external magnetic field of about 10-100 kA/m.

Subsequently two of the four magnetoresistive devices in the Wheatstone bridge are subjected to a (very) short current pulse. Due to this current pulse, the selected two magnetoresistive devices heat up to a certain temperature. If the temperature is high enough, the bias direction can be changed if simultaneously a strong magnetic field is applied. During cooling in the presence of the field, the magnetization direction is ‘frozen in’ in the antiferromagnetic material. It is also possible that the first step (i.e. the growth in magnetic field) is omitted. In that case, by reversing the magnetic field and sending a current pulse through the other two bridge devices, the bias direction in the latter two elements is reversed. In this way a full-functioning Wheatstone bridge configuration can be obtained. Variations in magnetization directions (as may e.g. occur during deposition) give rise to offset variation in a Wheatstone bridge and can be avoided to a large extent in this way.

In order to compensate for offset in the output characteristic of magnetoresistive devices in a Wheatstone bridge it is very advantageous to use a current pulse. The current pulse can be used to trim the resistance value of a single magnetoresistive device.

The resistance of each magnetoresistive device in the Wheatstone bridge can be changed selectively, without disturbing the other magnetoresistive devices. The use of a current pulse to tune a resistance is useful in particular, because special trimming resistances, which are usually necessary for trimming purposes, can be omitted. Another major advantage is that the offset compensation can be applied after packaging of a magnetoresistive device. Changes in resistance values during the packaging process can be compensated afterwards. The result is a reduced offset.

The current pulse can increase the resistance value of a magnetoresistive device because of intermixing of layers of the layer-structure. It is also possible to decrease the resistance value because of annealing out defects from the magnetoresistive layer-structure. The resistance value therefore can be changed irreversibly to a higher or a lower value.

In an advantageous embodiment of a Wheatstone bridge configuration, the magnetoresistive elements of the bridge having the same bias direction are grouped together very closely e.g. in a meander structure, while the other pair of magnetoresistive elements, which get the opposite bias direction, are grouped together very closely in a meander structure at a certain distance from the other grouped pair. An advantage is that the heating due to the current pulse is almost identical in the meandering elements positioned very close to each other. The current pulse can be applied at the same time by using the same contact pads. This configuration can also advantageously be used for measuring gradients in magnetic fields or temperature gradients, or e.g. as a flowmeter.

These and other features and advantages of the present invention will become apparent from the following detailed description, taken in conjunction with the accompanying drawings, which illustrate, by way of example, the principles of the invention. This description is given by way of example only, without limiting the scope of the invention. The reference figs. quoted below refer to the attached drawings.

### BRIEF DESCRIPTION OF THE DRAWINGS

FIG. 1 shows a schematic cross-section through a magnetic layer-structure.

FIG. 2 shows the resistance of the magnetic multilayer stack as a function of temperature.

FIG. 3 shows schematically the method of applying a short current pulse in combination with a magnetic field for setting the bias direction.

FIG. 4 shows the magnetoresistance curve after annealing in a reversed magnetic field with current pulses having a different duration: a) Starting situation, b) after a current pulse of 2 sec., and c) after a current pulse of 140 ms using the same starting position as in a).

FIG. 5 shows the resistance change after current annealing during 40 ms with current pulses having different amplitudes.

FIG. 6 shows a schematic energy diagram with two populations n₁(T,t) and n₂ (T,t) and their respective energy barriers ΔE₁ and ΔE₂.

FIG. 7 illustrates schematically different physical processes with different energy barriers at the same temperature that can be selected by choosing electric current pulses with varying pulse duration and amplitude. The y-axis is in arbitrary units.

FIG. 8 illustrates that a certain pulse time and amplitude can be used to separate two different processes with different energy barriers. The y-axis is in arbitrary units.

FIG. 9 shows a schematic representation cross-section through a magnetic multilayer structure comprising a first exchange bias layer and a second exchange bias layer.

FIG. 10 shows the behavior of a) the exchange-bias strength and b) the direction over a wide range of pulse times, and c) the exchange-bias strength for different temperatures.

FIG. 11 shows the relative exchange bias field of IrMn and PtMn (measuring time per point approximately 20 minutes) Solid line: measured, Dotted line: calculated

FIG. 12 shows a schematic representation of a Wheatstone bridge.

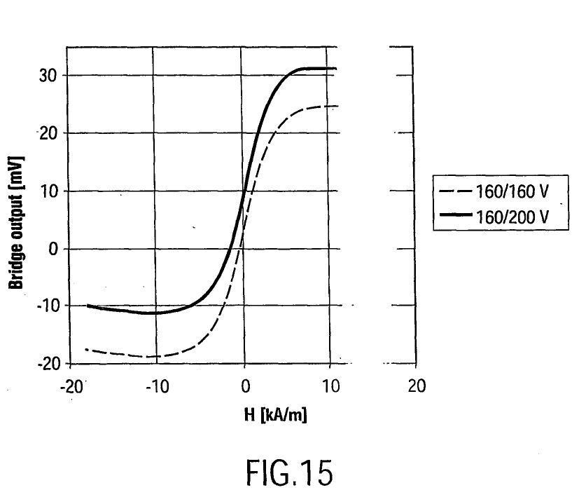

FIG. 13 shows:

a) Wheatstone bridge devices consisting of GMR stripes. The arrows indicate the desired magnetization direction of the devices. Black arrows show the magnetization direction of the exchange bias layer after deposition and the dashed arrows show the magnetization direction of the exchange bias layer after the current pulse anneal process. b) Output characteristics of the two half bridges of a single deposition sensor after deposition (open symbols) and after current anneal process (filled symbols), where the devices were heated by a short current pulse (100 ms, 100 mA) and an external field was used to reset the bias direction.

FIG. 14 shows an output characteristic of a single deposition GMR sensor optimized for rotational speed sensing. b) Comparison between the offset drift of GMR and AMR sensors. Data used for fits are 3 (μV/V)/K for AMR and 1 (μV/V)/K for GMR sensors.

FIG. 15 shows a Wheatstone bridge configuration in which current pulse annealing is applied to reduce the offset voltage.

FIG. 16 shows a Wheatstone bridge configuration with meander shaped magnetoresistive devices.

FIG. 17 shows an embodiment of an inventive Wheatstone bridge configuration in which the magnetoresistive devices having the same bias direction are grouped together and the magnetoresistive devices having the opposite bias direction are arranged at a certain distance and are also grouped together.

In the method of manufacturing a device 1 with a magnetic layer-structure 2, a short current pulse 3 is applied near or through the layer-structure.

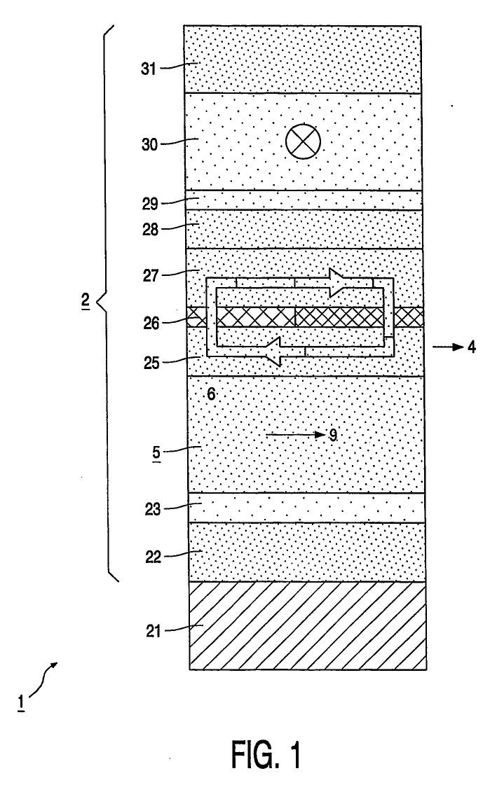

FIG. 1 shows a magnetic multilayer structure 2 that is made by sputter deposition. The GMR multilayer stack is deposited on a substrate 21 (e.g. glass, a semiconductor material like Si provided with a silicon oxide layer, or a ceramic material, such as Al₂O₃). A buffer layer to modify the crystallographic texture or grain size of the subsequent layer(s), if needed, is provided on the substrate. The buffer layer may comprise a first sublayer 22 of Ta (e.g. 3.5 nm thick) and a second sublayer 23 of NiFe (e.g. 2 nm thick). On the buffer layer, an IrMn exchange bias layer 24 (e.g. of 10 nm Ir₁₉Mn₈₁) is deposited. On top of the bias layer an artificial antiferromagnetic (AAF) stack is provided which comprises a first Co₉₀Fe₁₀ layer 25 (e.g. 4.5 nm thick), a Ru layer 26 (e.g. 0.8 nm thick) and a second Co₉₀Fe₁₀ layer 27 (e.g. 4.0 nm thick). On the AAF stack a non-magnetic spacer layer 28 is deposited. The spacer layer 28 can be a Cu-type material. By Cu-type is meant Cu (e.g. 2.2 nm thick Cu) or an alloy of Cu with a further metal, in particular Ag. On top of the spacer layer a layer 29 of Co₉₀Fe₁₀ (e.g. 1.2 nm thick) is provided which carries a Ni₈₀Fe₂₀ layer 30 (e.g. 9 nm thick). A protective layer 31 (e.g. of 10 nm Ta) covers the layer system.

The exchange biasing material 6 (IrMn) is hereinafter referred to as AF₁. The sequence of layers 4.5 CoFe/0.8 Ru/4.0 CoFe is referred to as the Artificial Anti-Ferro magnet (AAF). The Co₉₀Fe₁₀ layer 29 and the Ni₈₀Fe₂₀ layer 30 are together hereinafter referred to as the free layer.

The magnetic layer structure mentioned above (3.5 Ta/2.0 NiFe/10.0 IrMn/4.5 CoFe/0.8 Ru/4.0 CoFe/2.2 Cu/1.2 CoFe/9.0 NiFe/10.0 Ta) can also be reversed.

Alternatively, a suitable TMR multilayer stack can be: 5.0 Ta/30.0 Cu/3.5 Ta/2.0 or 3.0 NiFe/10.0 IrMn/4.0 CoFe/0.8 Al, oxidized/5.0 NiFe/10.0 Ta.

In an advantageous embodiment of the method, a short current pulse 3 is applied through the GMR multilayer structure of FIG. 1. This is done by applying a short voltage pulse across the magnetic multilayer stack, thereby inducing a current pulse. By applying a voltage pulse of a certain duration and amplitude, the magnetic multilayer stack is heated. This is called ‘current pulse annealing’. The duration and amplitude of the current pulse corresponds to a certain temperature inside the multilayer stack. Some electric conductance of the stack or in the immediate neighborhood of the stack is necessary to apply the method.

In the TMR stack mentioned above, the current pulse cannot be sent through the layer-structure; it would damage the oxide. In that case the current pulse can be sent through an electric conductor which is positioned near the TMR stack. The electric conductor track can for instance be positioned on the substrate and can be separated from the layer stack by a thin silicon oxide layer.

Experimentally it has been shown that a very short pulse of about 100-250 ns in an electrostatic discharge (ESD) event with a voltage of around 1000V does not lead to a significant change of the resistance value R of the MR multilayer stack, nor to a change of the magnetoresistance effect ΔR/R, and that it heats the device to above the blocking temperature (approximately 290° C.).

A pulse duration of 40 ms and a voltage of 160 V results in a temperature of around the blocking temperature of 10 nm thick IrMn, i.e. around 290° C.

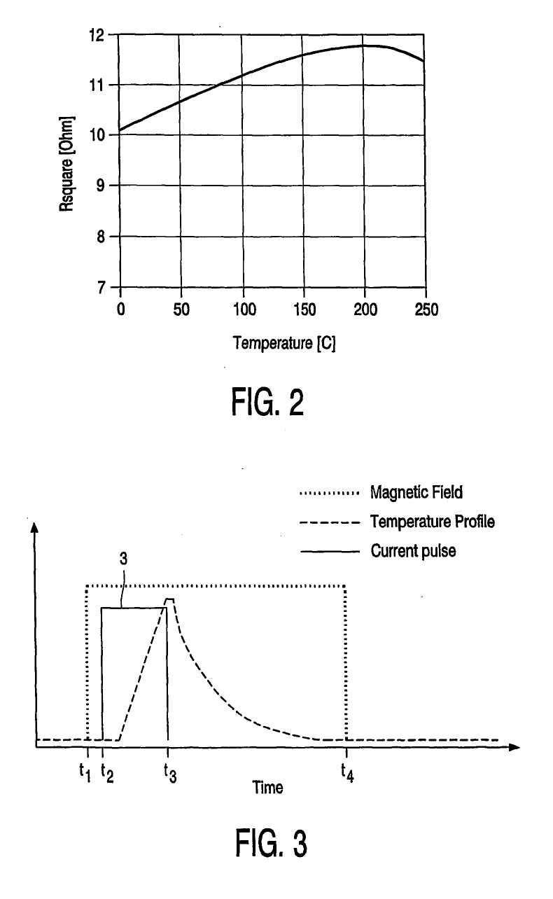

FIG. 2 shows the calculated square resistance of the multilayer stack as a function of temperature. To explain the curve shape in FIG. 2, some important material parameters of the multilayer stack are listed in Table 1.

TABLE 1
Resistivity at 20° C. and temperature
coefficient of various GMR stack materials.

| Material | Resistivity [cm] | Temp. coefficient [ppm/K] |
|---|---|---|
| Ta | 190 | −510 |
| Cu | 9.2 | 1070 |
| Ru | 36.6 | 1400 |
| IrMn | 237 | −3000 (20-80° C.) |
| CoFe | 36.0 | 1650 |
| NiFe | 26.0 | 1960 |

Table 1 summarizes the resistivities and the temperature coefficients of the various materials. The temperature coefficients have been measured for reasonably thick layers of 10 nm. The resistivity is dependent on the thickness of the film such that the resistivity increases with decreasing film thickness, especially for film thicknesses below 10 nm. With decreasing film thickness scattering effects at the interfaces become more important which result in a higher resistance. The total thickness of the GMR multilayer stack is usually larger than 40 nm.

In Table 1 it is assumed that the resistivities are independent of the layer thickness.

Most materials show a constant temperature coefficient, except for IrMn which shows a non-linear behavior. Between 20 and 80° C. the temperature coefficient is 3000 ppm/K, but at higher temperatures the temperature coefficient decreases.

In this specific embodiment no substantial heat transfer from the multilayer structure to the environment of the multilayer structure took place when the electric current pulse had a duration of less than 100 ms and the amplitude of the voltage pulse was around 160 V. The temperature of the substrate before and after the current pulse was substantially the same. No influence on the output characteristic of neighboring magnetoresistive devices is observed.

Application of the method in the manufacturing of devices is manifold: magnetic sensing systems for e.g. automotive applications, magnetic recording, bio-sensors, 3D compasses, in mobile phones, in data storage systems such as MRAM, ICs, magnetic stacks, electric stacks and so on.

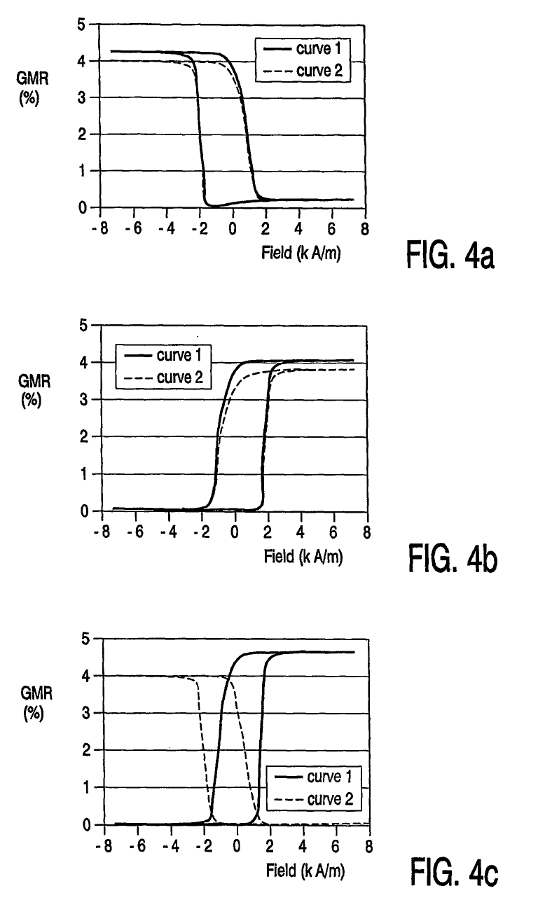

The current anneal process uses current pulses on the time scale of hundreds of milliseconds or faster to set the magnetization direction 9 of the bias layer 5 in the multilayer stack. The exact process is depicted in FIG. 3. At time t₁≦t₃ a strong magnetic field is applied in the desired direction (dotted line). At t₂ a current pulse 3 is applied to the magnetic layer structure that is high enough to heat the device to above its blocking temperature (solid line). At t₃ the current is switched off. The duration of the current pulse should be in the hundreds of millisecond range or faster (t₃−t₂<100 ms.). The current pulse heats the bias layer 5 to above the blocking temperature and the magnetization direction 9 of the bias layer is (re) set in the direction of the applied magnetic field. The temperature is indicated as a dashed line. It is very important that the magnetic field is still present while the magnetic multilayer structure cools down. At time t₄ the magnetic field can be switched off.

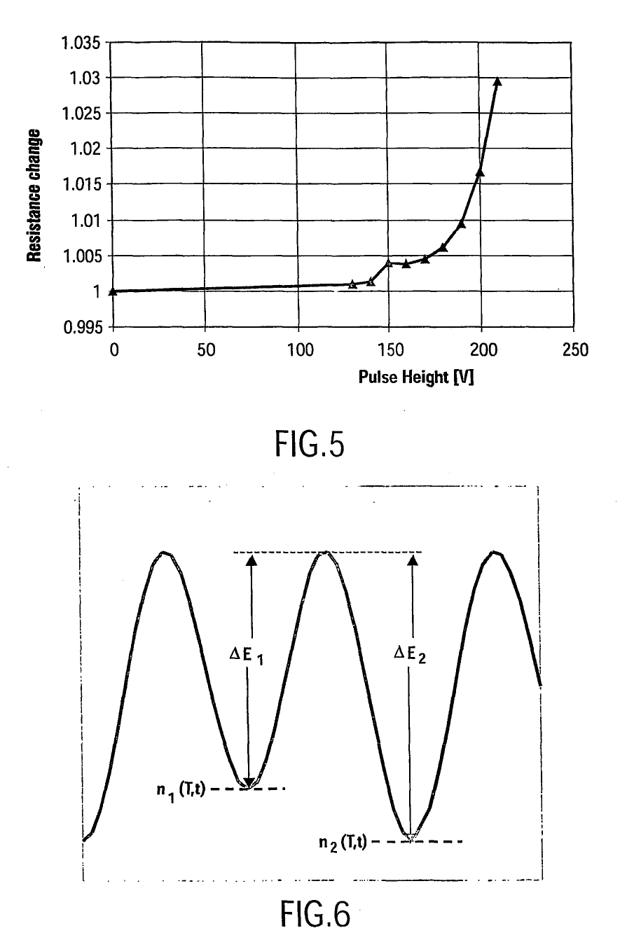

The duration of the current pulse plays an important role in this process. In FIG. 4a the magnetoresistance curves of two neighboring devices are shown (curve 1 and 2). The distance between the devices is 300 μm. FIG. 4b shows the output curves of the two devices after the bias direction of only one device (curve 1) has been deliberately reversed by a current pulse of 2 seconds in the presence of a reversed field. It is apparent that the bias direction of the other device has been rotated as well. In FIG. 4c the bias direction of said one device (curve 1) has been deliberately reversed by a voltage pulse of 140 ms. By using a very short current pulse it is possible to reverse the magnetization direction of the individual devices without affecting the bias direction of their neighbors (curve 2 is not altered). This pulsing technique still works even when the devices are only 100 μm apart. The distance between neighboring devices can be reduced further if even faster current pulses are used.

The resistivity of a material or of a multi-layer stack of materials like the one which is used in a GMR sensor, changes when the stack is heated. The change in resistivity is partially reversible and partially irreversible.

The irreversible change in resistivity can be negative, meaning that the resistance decreases. E.g. this is typically caused by the annealing of defects in the material. Defects are trapping centers for conduction electrons and will affect the resistivity of a material.

The irreversible change can also be positive, meaning that the resistance increases. Such an effect is normally caused by diffusion effects which cause intermixing of materials. Depending on the temperature the resistance changes can be small or large, meaning that the resistance can be changed permanently by using a suitable temperature.

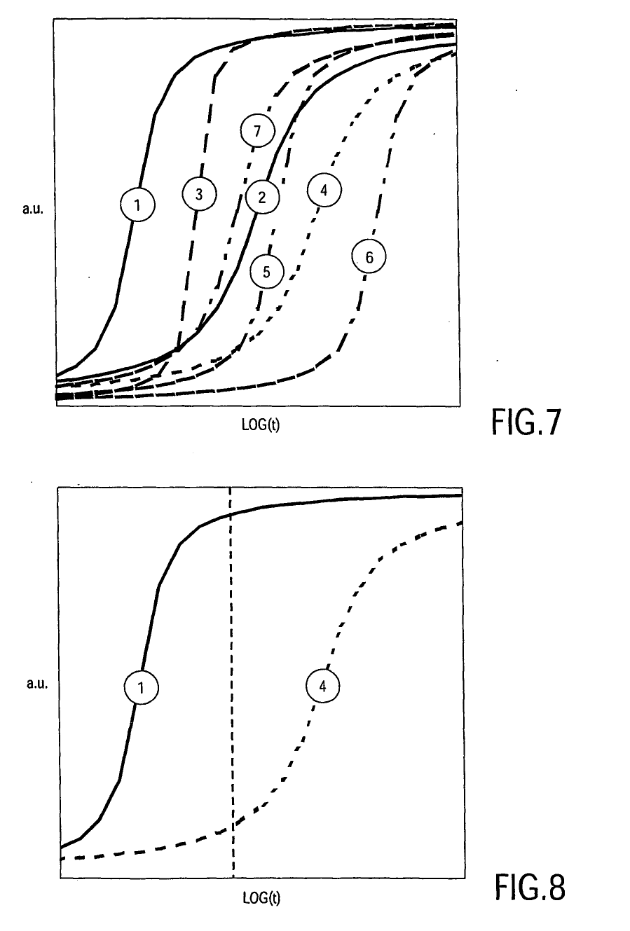

FIG. 5 shows the change in resistance of the GMR multilayer stack of FIG. 1 as a function of the height of the voltage pulse applied across the resistor. In this case the pulse time is 40 msec. At 160 V pulse height rotation of the bias layer is complete, indicating that the temperature is close to the blocking temperature of the exchange biasing material, IrMn, which is approximately 290° C. as determined by VSM using normal measuring times. By increasing the pulse height, the current through the resistor becomes higher and the temperature of the resistor increases. The increased temperature enhances the effect of interdiffusion. At 200 V the resistance has increased by almost 2%.

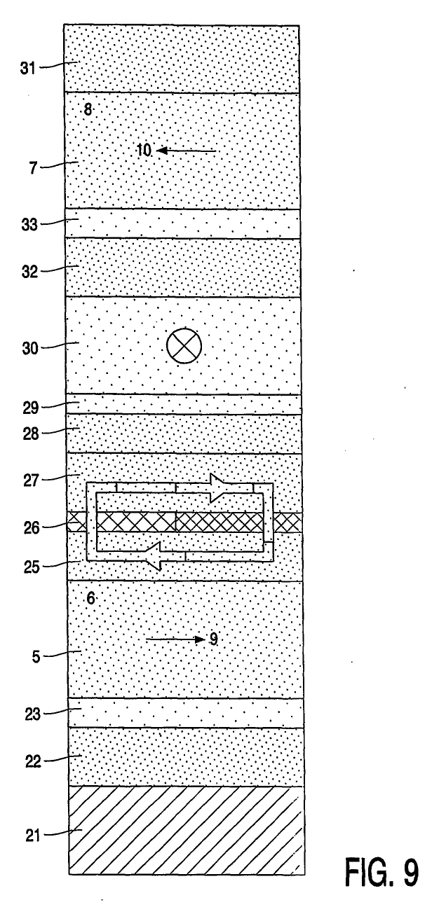

In the previous example, two processes evolve in the device: magnetization rotation and diffusion. For other applications it is necessary to separate such processes by making use of the difference in their activation energies. This will be illustrated in the following. FIG. 6 schematically illustrates the total energy as a function of the magnetization direction in the AF material for a configuration containing a ferromagnetic (FM) material in contact with an antiferromagnetic material AF. The AF material is assumed to be polycrystalline containing isolated grains. Suppose that without an applied field, the magnetization in the AF and the FM layer is in the same direction and that the magnetization direction in the AF grain is along the anisotropy axis of the grain. That is to say, the magnetization is in an energy minimum with a population of magnetic moments n₁(T,t). Now, if a strong magnetic field is applied in the opposite direction, the magnetic moments in the FM layer will respond to the field and will orient in the direction of the field. Simultaneously, these magnetic moments will try to reverse the magnetic moments in the AF grain via the exchange bias coupling. Since the magnetic moments in the AF grain were already in an energy minimum, they will not immediately rotate towards the opposite direction. Although the opposite direction is an energy minimum again, both energy minima are separated by an energy barrier ΔE₁ which cannot be overcome by the magnetic moments unless there is sufficient thermal energy added. Therefore, the ratio between the thermal energy kBT and the energy barrier ΔE₁ is important for the switching behavior of the magnetization in the AF grain and the overall magnetization direction will be a function of temperature. Due to the statistical behavior of the thermal fluctuations, it will be a matter of time and temperature whether the magnetic moments will pass the energy barrier. Therefore the overall magnetization direction will also be a function of time and temperature. By using the current pulse anneal technique, time and temperature can be controlled in order to achieve the desired magnetization direction.

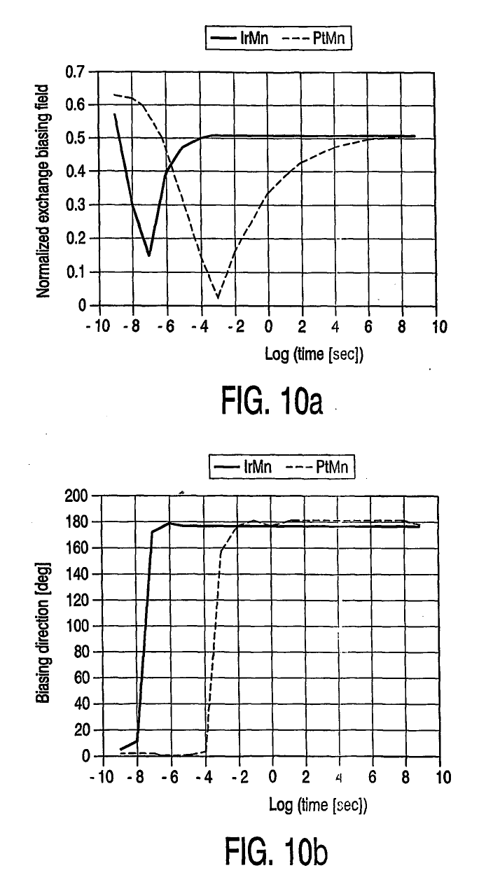

FIG. 7 illustrates schematically different physical processes with different energy barriers at constant temperature. Selection between processes is obtained by choosing electrical current pulses of varying pulse duration and amplitude.

The vertical axis of the different curves represents different properties such as e.g. angle, resistance, crystalline state. Position and curve shape are dependent on the material and the temperature used.

(Local) Processes that take place during the above described selective current pulse anneal treatment can be: diffusion (of atoms), the change of composition at interfaces, the change of strength or direction of pair ordering (easy axis orientation), the change of magnetization direction, the change of structure or phase (amorphous/crystalline/crystalline orientation), the change of stress and strain, the change of the concentration of a dopant near the surface (or near an interface).

Examples of the schematic curves in FIG. 7 are:
1. Rotation of magnetization (e.g. AF material 1)
2. Rotation of magnetization (e.g. AF material 2)
3. Property due to small atom-displacement (e.g. rotation of easy axis)
4. Property due to large atom-displacement (e.g. resistance)
5. Phase change transition (e.g. amorphous-crystalline material 1)
6. Phase change transition (e.g. amorphous-crystalline material 2)
7. Transition from isolation state to (semi)conduction state (e.g. due to dopants or material change)

The rotation of the magnetization direction can occur very fast because in general no atom displacements are involved in this process.

The relaxation of the anisotropy of NiFe (Permalloy) films involves reorientation of atom pairs because pair ordering is the major source of anisotropy in Permalloy films. Since this involves small atom displacements, it is in general a slower process than the rotation of a magnetization. Pair reorientation is directly related to the vacancy concentration. The time necessary for these processes to take place is approximated by t=τₒ exp E_{A}/k_{B}T. The activation energy for pair ordering in the free layer is higher (E_{A}≈1.3 eV) than the activation energy for changing the magnetization direction in the pinned layer (1 eV), and the τ_{o free layer}≈2.10⁻¹⁵ min, whereas τ_{o pinned layer}≈4.10⁻¹⁰ min. (literature: “Thermal relaxation of the free layer anisotropy in spin valves”, L. Baril, D. Mauri, J. McCord, S. Gider and T. Lin, J. Appl. Physics, Vol. 89, No. 2, 15 Jan. 2001, p. 1320-1324).

Based on these values, the anisotropy axis is rotated almost completely during 600 nsec at a temperature T=800 K. For comparison, at room temperature T=300K, this takes 2.5 years.

Rotation of the magnetization is one of the fastest processes and can already occur at very short pulse durations in the ns range, whereas diffusion processes are slower processes. For the phase change of most materials, e.g. from an amorphous to a crystalline phase, more power is needed and the pulse duration is for that reason usually much larger although there are exceptions such as phase-change materials for CD recording.

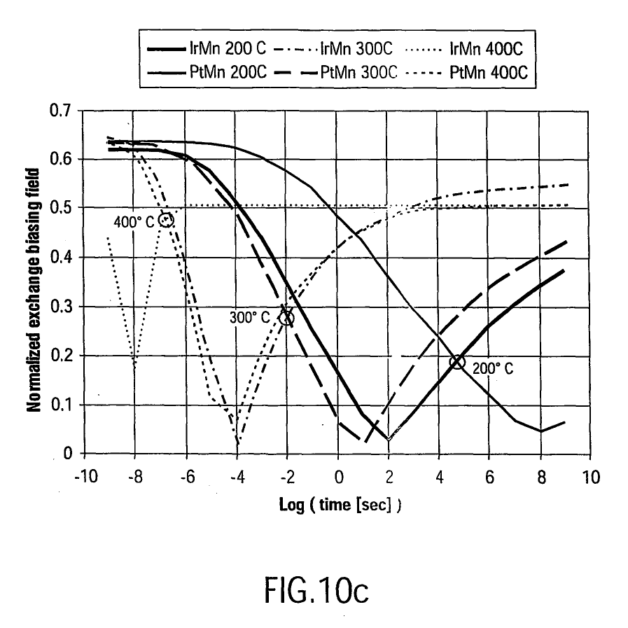

FIG. 8 illustrates that time can be used to separate two different effects. In this case a pulse time is chosen which hardly affects the resistance (curve 4), while it completely changes the direction of magnetization in AF material 1 (curve 1).

The vertical axis of the different curves again represents different properties such as e.g. angle, resistance, crystalline state.

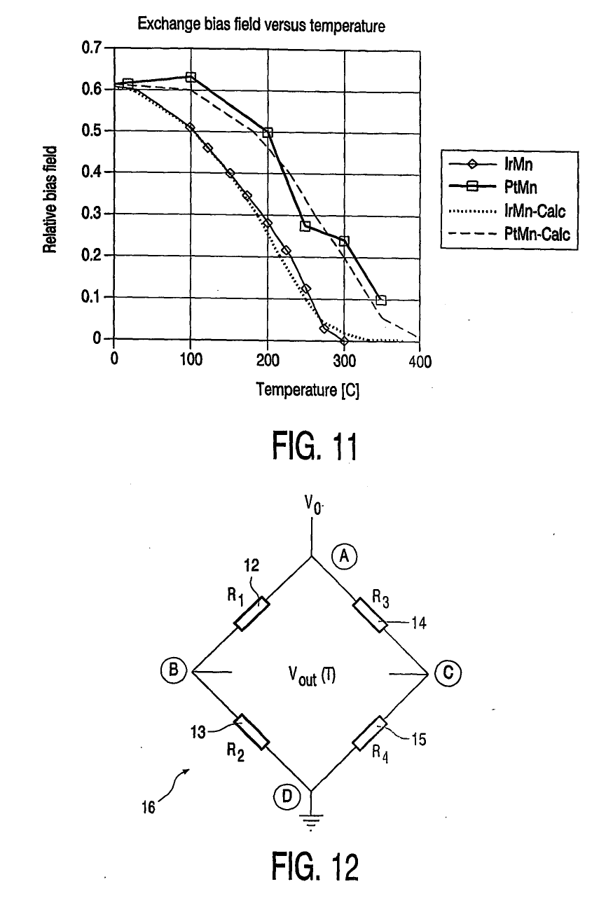

As an example, FIG. 9 shows a multilayer structure comprising two exchange biasing materials 5, 7 with different Blocking temperatures to which the method of selective current pulse annealing can be applied advantageously. By choosing a proper time and amplitude for the current heating pulse, one exchange bias layer in the stack can be selectively altered.

In the embodiment of FIG. 9 the multilayer structure comprises the GMR stack 3.5 nm Ta/2.0 nm NiFe/10.0 nm IrMn/4.5 nm CoFe/0.8 nm Ru/4.0 nm CoFe/3.0 nm Cu/1.2 nm CoFe/9.0 nm NiFe with an additional stack 32,33,34: x nm Ta/4.0 nm CoFe/10.0 nm X—Mn/10.0 nm Ta. The first exchange bias layer 5 (AF₁) in this case is IrMn, the second exchange bias layer 7 (AF₂) is X—Mn in which X is for example Pt or Ni.

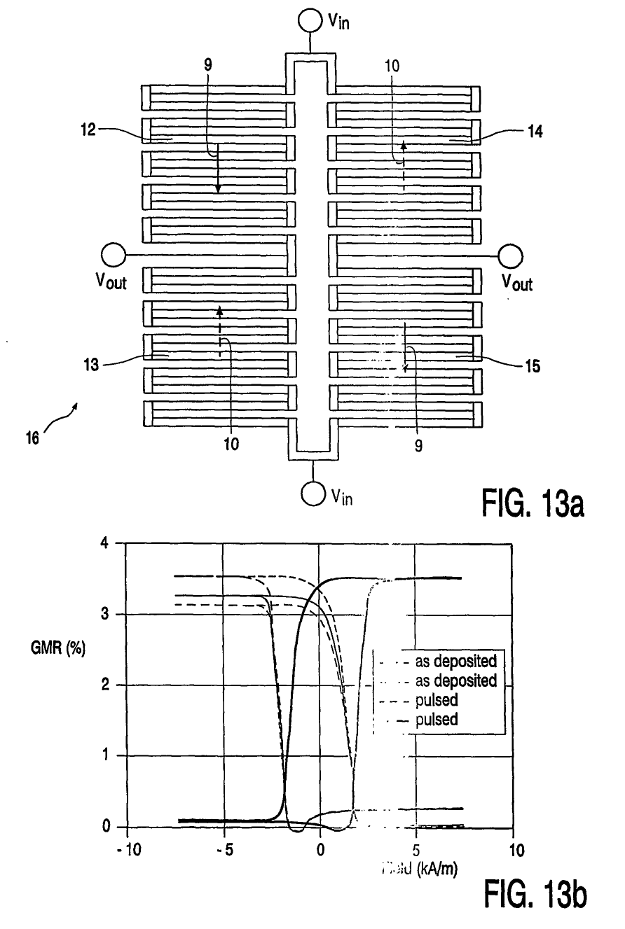

The behavior of the exchange-biasing strength and direction are shown in FIGS. 10a and 10b over a wide range of pulse times.

The temperature of the device has been fixed at 375° C. and the applied magnetic field is set in the opposite direction to the initial bias direction. Due to the influence of time and temperature, the bias direction changes from 0° to 180°. FIG. 10a shows the normalized exchange bias strength as a function of pulse time for both the IrMn (solid line) and PtMn (dashed line) AF material. The dip in the curve indicates the pulse time at which the magnetization changes direction. FIG. 10b shows the exchange bias direction. It can be seen that at a pulse time longer than 1 sec the exchange bias field 9 in the IrMn (solid line) can be changed almost completely (i.e. direction as well as strength) while the exchange bias field 10 of the PtMn (dashed line) is hardly affected. So, by choosing a proper time and temperature for the heating pulse, one exchange bias layer in the stack can be selectively altered.

In the example the selection is based on the following physical principle:

An exchange biasing film is characterized by its so-called Blocking temperature, T_{B}. If the temperature of the film exceeds the Blocking temperature, the direction of the magnetization in the AF material can be easily changed to the direction of the applied field, (for clarity the magnetization direction in the AF material is changed via the magnetization direction in the ferro-magnetic layer which is exchange-coupled to the AF material). By making use of two different exchange biasing materials with substantially different blocking temperatures (T_{B,1} and T_{B,2}), the magnetization direction of one material can be changed when it is heated (to above its blocking temperature T_{B,1}) in the presence of a field while simultaneously the other material is unaffected at the same temperature (below its blocking temperature T_{B,2}) and magnetic field. In this way, within one element two different exchange bias directions can be realized independently.

In FIG. 10c the exchange bias strength is shown for different temperatures.

This fig. clearly shows that another advantage of using short pulse times is that the selectivity between the two processes can be enhanced by using shorter pulse times and higher amplitudes (temperatures) of the current pulse.

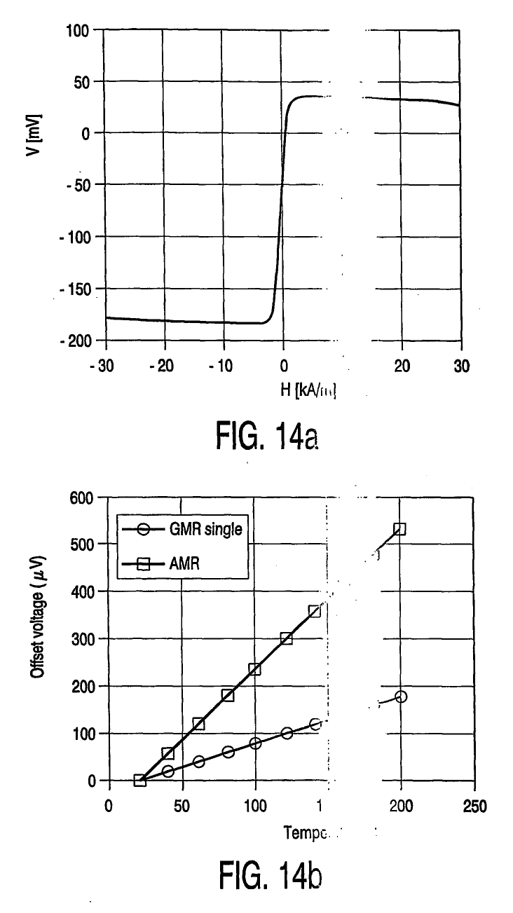

The Blocking temperatures for IrMn and PtMn have been measured by means of VSM measurements. The results are given in FIG. 11. The fig. shows the exchange bias field on the vertical axis as a function of temperature. It can be clearly seen that IrMn (solid line) and PtMn (dashed line) have different blocking temperatures, with PtMn having the higher blocking temperature. The dotted lines in the fig. result from a calculation which simulates the behavior of the AF material assuming a realistic log-normal grain/particle-size distribution in the AF layers. The Néel-temperature and the anisotropy constant of the AF material have been extracted from the measured data.

With the aid of a sequence of short and ultra-short (current and eventually laser) pulses of various duration and amplitude (or one short or ultra-short current pulse of specific duration and amplitude), different processes in a stack and processes in stacks at different positions can be influenced selectively. It is possible to optimize characteristics of the stack in this way that cannot be optimized in any other way. Magnetic and/or electric fields, mechanical stress, gas flow and so on can be applied during the ‘current pulse anneal’ treatment.

The current pulse method can be used advantageously to manufacture magnetic devices such as in a sensing system 11 of magnetic properties. Magnetic sensors are widely used for all kinds of applications especially in the automotive industry. Sensors can be based on the AMR (Anisotropic Magneto Resistance) effect, for application in ABS brake systems and for rotational speed measurement in automotive applications. There is an ongoing interest in more sensitive sensors, using e.g. GMR (Giant Magneto Resistance), GMR with NOL (Nano-Oxide Layers) or even TMR (Tunnel Magneto Resistance). Typical requirements for such sensors include high temperature stability for prolonged operation at higher temperatures (typically 200° C.), low offset-voltage, low offset-voltage drift, low noise and low hysteresis.

Most magnetic sensors are based on a Wheatstone bridge configuration 16, consisting of four resistors 12,13,14,15 made out of magnetic material and connected to each other by four terminals (see FIG. 11). The magnetic material normally consists of AMR, GMR or TMR material. The four terminals provide input and output to the bridge. Wheatstone bridges are normally used because of their temperature independent behavior, at least the temperature dependent characteristics of the sensor are greatly reduced by the use of such a configuration. The bridge is connected to a Voltage source or Current source by means of two terminals (e.g. terminals A and D in FIG. 11).

In an advantageous embodiment, the magnetic device is a GMR sensor for rotational speed sensing. The sensor layout is a full Wheatstone bridge configuration with an active area of less than 0.3 mm². It consists of a spin valve with an exchange bias Artificial AntiFerromagnet (AAF) as described in FIG. 1. This structure is stable up to fields of at least 200 kA/m and can withstand operation temperatures exceeding 170° C., which makes it suitable for automotive applications.

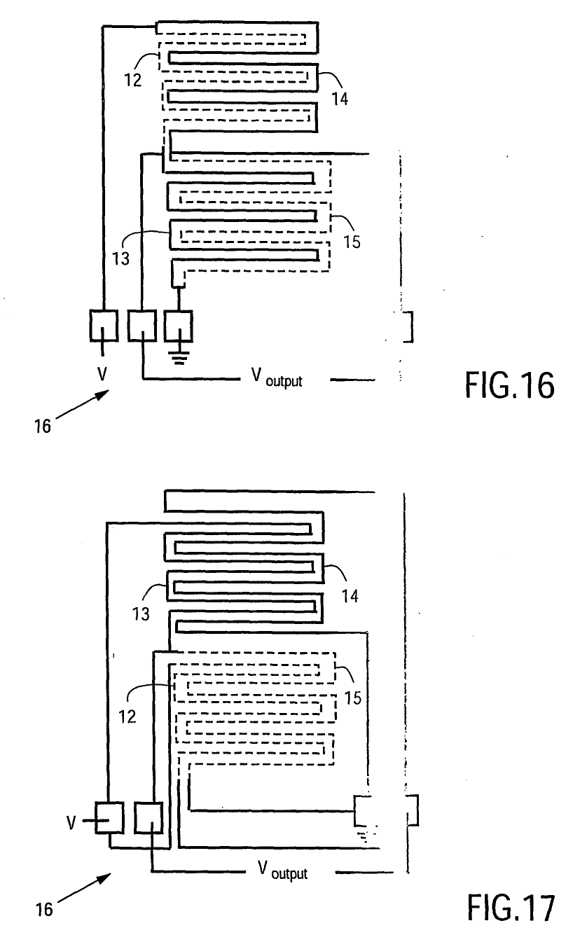

All devices are deposited using a single deposition process. The magnetization directions of two devices of the bridge have to be rotated by 180° in order to obtain the maximum output from the GMR sensor (see FIG. 13a). The Wheatstone bridge devices consist of GMR stripes. The arrows 9, 10 indicate the desired magnetization direction of the devices. Black arrows 9 show the magnetization direction after deposition and the dashed arrows 10 show the desired magnetization direction of two bridge devices. The magnetization directions 10 of the two bridge devices can be achieved via the current pulse anneal process where individual devices 13,14 are annealed above the blocking temperature and a strong magnetic field is used to set the magnetization direction of the device. This process can be performed without influencing the magnetization direction of neighboring devices. This factor becomes even more crucial, considering the small distance between the devices of around 50 μm.

FIG. 13b shows the results of a current pulse anneal process applied to a single deposition sensor. The individual devices were heated by a short current pulse (100 ms, 100 mA) and an external field of 2500 Oe was used to set the bias direction of the half bridge. The output curves represent the individual half-bridges of the sensor (e.g. devices with the same magnetization direction). After deposition both half bridges show very similar output characteristics (open symbols). Using the current pulse anneal process the magnetization directions of the half bridges were set in opposite directions (filled symbols). The fact that after setting the magnetization direction of the individual half-bridges both half-bridges exhibit the same maximum GMR effect and have an opposite characteristic shows that the magnetization direction of one half bridge has been rotated without influencing the magnetization direction of the neighboring device.

The bridge output of an optimized single deposition GMR rotational speed sensor is shown in FIG. 14a. The active area of the sensor is about 0.25 mm². The sensor shows a high sensitivity between 10-18 (mV/V)/(kA/m) and hysteresis of less than 0.1 kA/m at small fields. At larger fields the sensor output remains constant up to fields of 30 kA/m. Measurements of the GMR speed sensor against an active target wheel produced reliable output signals and an increase in the maximum air gap of more than 20% compared to commonly used AMR sensors.

This current pulse anneal process can also be used to produce on-chip GMR angle sensors in a single deposition process. This results in a significant reduction in sensor size and improvements in the accuracy of the sensor.

The excellent performance of the GMR rotational speed sensor can be attributed to the unique combination of high sensitivity, low hysteresis at small fields and constant output modulation at large fields.

When the four resistors in the bridge in FIG. 11 all have the same resistance value, the output voltage, being the voltage measured between the two terminals which are not used for bringing power to the Wheatstone bridge (e.g. terminals B and C), is zero at zero magnetic field (Hₐₚₚ) applied to the bridge. A zero-output voltage at Hₐₚₚ=0 is desired for most applications. In this case it is said that the offset-voltage is zero. Small changes in the values of the resistors (e.g. caused by the applied magnetic field) cause the bridge to unbalance, giving a non-zero output voltage at non-zero magnetic fields. Therefore, from design the Wheatstone bridge is very sensitive to variations in the resistances. However, these small resistance variations can also be caused by the production method of the magnetic sensor. In a production environment, it is practically almost impossible to make the four resistors in such a way that their resistance values are exactly the same. Since it has already been mentioned that the bridge is sensitive to small deviations in resistance, the output voltage will be non-zero at Hₐₚₚ=0. This non-zero output-voltage is called the offset of the bridge.

FIG. 14b compares the offset drift of a GMR sensor with that of a commercially available AMR sensor. The offset drift of the single deposition GMR sensor is around 1 (μV/V)/K and it is approximately a factor of three better than the offset drift of commonly available AMR sensors used for rotational speed sensors.

In order to correct for this non-zero offset-voltage, a trimming procedure is often used after the complete device has been finished on wafer level. Each Wheatstone bridge is equipped with two trimmable resistors, each in one diagonal of the bridge. By means of cutting metal connections with a laser, the value of these trim resistors can be changed and finally the output voltage of the bridge at Hₐₚₚ=0 can be trimmed to zero. Because the devices have to be accessible to the laser trimming device, this procedure can only be applied at wafer level. Once the sensor is packaged, the offset in output voltage due to e.g. thermal processing during packaging, cannot be corrected anymore.

The current pulse method can be applied to reduce the offset-voltage of a Wheatstone bridge configuration by means of the ‘current pulse annealing’ technique.

The method can replace the laser trimming procedure as is currently used during the production of AMR sensors, and has the advantage of being applicable to packaged sensors. Because the trimming procedure can be applied as a final treatment at the end of the packaging line, extra shift in the output voltage that may occur during packaging can also be corrected.

The described trimming method by means of current pulses is based on two phenomena.

The first one is the fact that the resistivity of a material or of a multi-layer stack of materials like the one which is used in a GMR sensor, changes when the stack is heated. The change is partially reversible and partially irreversible.

The irreversible change in resistivity can be negative, meaning that the resistance decreases. E.g. this is typically caused by the annealing of defects in the material. Defects are trapping centers for conduction electrons and will affect the resistivity of a material.

The irreversible change can also be positive, meaning that the resistance increases. Such an effect is normally caused by diffusion effects which cause intermixing of materials. Depending on the temperature the resistance changes can be small or large, meaning that the resistance can be changed permanently by using a suitable temperature.

The 2^{nd} phenomenon is based on the fact that a shift in offset-voltage in a bridge is caused by only a small change in the resistance. E.g. the shift in offset-voltage typically is about 5 mV/V per 1% change in resistance. Since the shift in offset-voltage in practice (due to the spread in the production of these resistors) is between −10 mV/V and +10 mV/V, a variation of only ±2% in one of the resistors is sufficient to compensate for this shift. Such a variation in resistance can easily be achieved by means of heating the resistance.

FIG. 5 showed the change in resistance of a GMR multilayer stack as a function of the height of the voltage pulse applied across the resistor. The pulse time was 40 msec. At 160 V pulse height rotation of the bias layer is complete, indicating that the temperature is close to the blocking temperature of the exchange biasing material, IrMn, which is approximately 290° C. By increasing the pulse height, the current through the resistor becomes higher and the temperature of the resistor increases. The increased temperature enhances the effect of interdiffusion. At 200 V the resistance has increased by almost 2%.

FIG. 15 shows two output curves of a complete Wheatstone bridge. The first output curve relates to a bridge where all bridge devices (resistors) have been ‘current’ annealed by pulses with a pulse height of 160 V during 40 ms (dashed line). The second output curve (solid line) shows a Wheatstone bridge where the devices on one diagonal have been annealed with 160 V pulses during 40 ms while the devices on the other diagonal have been annealed with 200 V pulses during 40 ms. It is clearly visible that in this case a shift in offset-voltage of about 7-8 mV can be achieved by this current annealing method. Despite the effects of interdiffusion, no changes in the magnetic characteristics of the sensor are observed.

The proposed method of offset-voltage trimming can be combined with the above described method of setting the bias direction by means of current annealing. Dependent on the application, the trimming has to take place in a magnetic field or not. The method eliminates the laser trimming procedure used in production while simultaneously offering a method that improves the final performance of the packaged product with respect to offset-voltage.

A problem arises when the heat of a particular device will spread to neighboring devices.

In that case the direction of the pinned layer of the neighboring device might be altered too. This problem becomes even worse if the devices of the bridge are meandering into each other. A Wheatstone bridge using this layout is shown in FIG. 16. An advantage of such a layout is the reduction in offset voltage drift caused by small changes in layer film thickness and properties. Furthermore it reduces the effect of magnetic field gradients. The different line patterns (solid and dashed) indicate the different directions for the pinned layer.

In order to solve this problem, in an advantageous embodiment the Wheatstone bridge is arranged in a slightly different way so that the two meanders with equal properties (i.e. having the same pinned layer direction) are grouped together as sketched in FIG. 17. In this way bridge devices with the same properties are grouped together while bridge devices with different properties (i.e. opposite pinned layer directions) are separated from each other. The heating of sensor devices with equal properties in the new layout (FIG. 17) is less likely to influence the sensor devices with different properties than in the original layout (FIG. 16).

1. Method of manufacturing a device (1) with a magnetic layer-structure, the method comprising the steps of:
forming the magnetic layer-structure (2),
heating the magnetic layer-structure with an electric current,
characterized in that the electric current is a pulse (3) having a duration such that no substantial heat transfer from the layer-structure (2) to the environment (4) of the layer-structure takes place, so that the temperature of said environment before and after the current pulse is substantially the same.

2. Method as claimed in claim 1, characterized in that the heat is transferred by means of heat conduction.

3. Method as claimed in claim 1 or 2, characterized in that the electric current pulse (3) is used to select a physical process in the layer-structure, the duration and amplitude of the pulse being adapted to the activation energy of this physical process.

4. Method as claimed in claim 3, characterized in that the selection of the physical process is improved by increasing the amplitude of the pulse and decreasing the pulse duration.

5. Method as claimed in claim 1, characterized in that a sequence of current pulses is applied without substantial heat transfer from the layer-structure to its environment (4).

6. Method as claimed in claim 1 to 5, characterized in that the device (1) is a magnetoresistive device.

7. Method as claimed in claim 6, characterized in that the device (1) is a sensing device.

8. Method as claimed in claims 1 to 7, wherein the magnetic layer-structure (2) comprises at least one bias layer (5), characterized in that a magnetic field is applied during the short pulse, which magnetic field is switched off after the temperature of the bias layer has decreased to below the Néel or Curie temperature.

9. Method as claimed in claim 7, wherein the magnetic layer-structure comprises a first bias layer (5) having a first antiferromagnetic material (6) with a first blocking temperature and a second bias layer (7) having a second different blocking temperature, characterized in that first the magnetization direction (9) of the material having the higher blocking temperature is set and subsequently the magnetization direction (10) is set of the material having the lower blocking temperature.

10. Method as claimed in any of the preceding claims, characterized in that the duration of the electric current pulse (3) is shorter than 100 ms.

11. Method as claimed in claims 8, 9 or 10, wherein the device is used in the manufacture of a magnetic system (11) having several magnetoresistive devices.

12. Method as claimed in claim 11, characterized in that at least four magnetoresistive devices (12,13,14,15) are formed and arranged in a Wheatstone bridge configuration (16).

13. Method as claimed in claims 11 or 12, characterized in that the current pulse is applied for offset compensation by irreversibly changing the resistance of at least one of the bridge devices (12;13;14;15) through local heating.

14. Wheatstone bridge manufactured as claimed in claim 12, characterized in that bridge devices (12,15) having the same magnetization directions in the bias layer are grouped together while bridge devices (13,14) having different magnetization directions are grouped together such that they are spatially separated from the other group.

15. Wheatstone bridge as claimed in claim 14, characterized in that the grouped bridge devices (12,15;13,14) have interleaved meander shapes.
